(19) United States
(12) Patent Application Publication
(10) Pub. No.: US 2009/0056420 A1
(43) Pub. Date: Mar. 5, 2009

(54) Percolation test timer

(76) Inventor: David Joseph Tompkins, Southington, CT (US)

Correspondence Address: David Tompkins, 91 Lowrey Dr., Southington, CT, 06489, US

(21) Appl. No.: 11/895,777

(22) Filed: Aug. 27, 2007

(51) Int. Cl. G01N 15/08

(52) U.S. Cl. 73/38

(57) ABSTRACT

A device to aid in the testing procedure for soil percolation used in the design of septic systems. The device is used to measure the rapidity of a change of water surface elevation. The device comprises one or more timers (24) connected to a series of sensors so that a change in the presence of water at specific elevations will start or stop a timer. The rate of water absorption and the hydraulic conductivity of the soil are then calculated from the values on the timers.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention generally relates to water level measuring devices, specifically for the purpose of soil percolation testing used in designing leaching fields.

2. Prior Art

The common method for testing soil percolation is to dig a hole approximately five inches in diameter by two foot deep, fill the hole with water, then measure the distance from the ground surface to the water surface at ten minute intervals for one hour. Devices for expediting this process are well known in the art. Many percolation test devices required the operator to be present for the duration of the test. This does not achieve the primary goal of the current invention which is to free the tester from needing to be present. Some devices have been created which do free the operator from needing to be present for the test, but they are not without drawbacks. Examples of such prior art apparatus are found in U.S. Pat. Nos. 4,182,157; 4,341,110; and 7,059,174 B2. The prior art show weaknesses when used for the soil percolation testing commonly done for septic system design. These include having a two-foot rod that prevents the device from fitting in a pocket and having movable parts susceptible to jamming or breakage. Also, parts can be lost from devices with multiple pieces and designs with floats can jam or break. Some devices are for long tests, precise measurements, or otherwise poorly serve the needs of this type of testing. The sophisticated designs incur higher fabrication costs. Currently, percolation testing for a septic system is still typically preformed by measuring the water surface level at ten-minute intervals for one hour.

3. Objects and Advantages

Accordingly, several objects and advantages of the invention are:
(a) to provide a device which frees a person from being present for the hour-long measuring portion of a percolation test;
(b) to provide a device that is simple enough for inexpensive fabrication;
(c) to provide a device which is compact, lightweight, and easy to carry to the test site;
(d) to provide a device which is easy to set up securely and to make plumb;
(e) to provide a device which lacks parts which are movable or prone to breaking or malfunction;
(f) to provide a device which lacks consumable parts;
   Further objects and advantages will become apparent from a consideration of the ensuing description and drawings.

### SUMMARY

In accordance with the invention, a Percolation Test Timer comprises a means of recording the time for the water level in a hole to change between two elevations. These water elevations are measured by electric sensors that respond differently to being in air versus being under water.

### DRAWINGS

### Figures

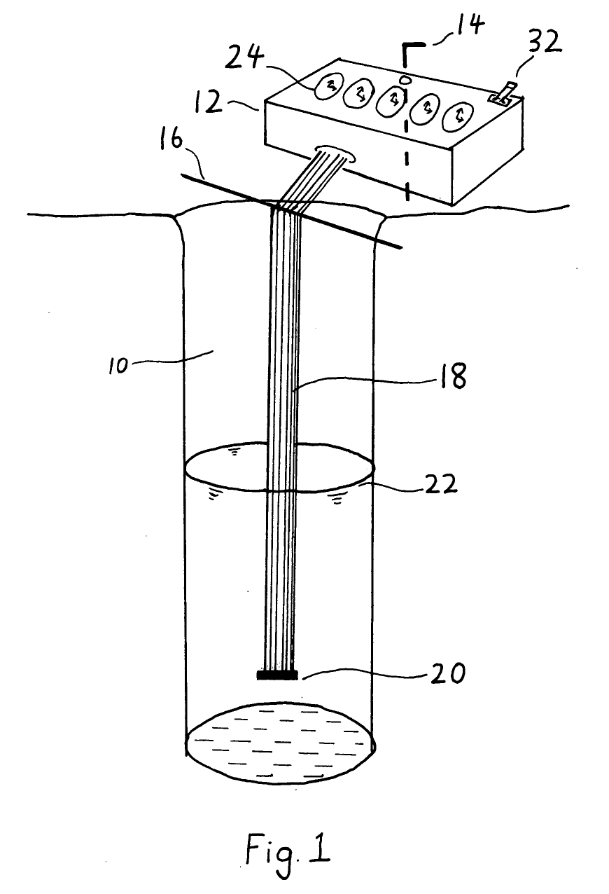

FIG. 1 shows the timer in use.

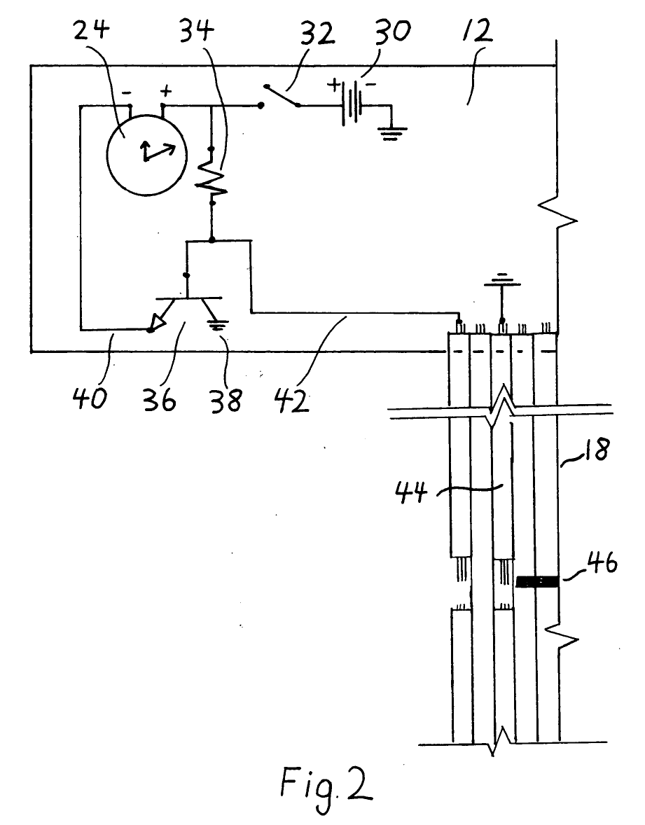

FIG. 2 shows the schematics of inside the circuit box and also shows a water sensor.

### DRAWINGS

### Reference Numerals

| | | | |
|---|---|---|---|
| 10 | percolation test hole | 12 | circuit case |
| 14 | circuit case anchor | 16 | multiple wire ribbon anchor |
| 18 | multiple wire ribbon | 20 | weight |
| 22 | the water surface | 24 | timer |
| 30 | battery | 32 | on/off switch |
| 34 | resistor | 36 | NPN transistor |
| 38 | ground-terminal wire | 40 | emitting-terminal wire |
| 42 | base-terminal wire | 44 | grounded wire |
| 46 | line marking the | | |
| | location of the top sensor | | |

### DETAILED DESCRIPTION

### FIGS. 1 and 2

### Preferred Embodiment

A preferred embodiment of the present invention is illustrated in FIG. 1 (orthogonal view), and FIG. 2 (schematic view). In FIG. 1, the device has a circuit case 12 with timers 24 visible on it. In FIG. 2 there is a circuit inside the circuit case 12 which includes a battery 30 and an on/off switch 32. The base-terminal of the NPN transistor 36 is positively charged through a resistor 34. This resistor 34 has a higher resistance than the water which would close the 3 mm gap between the ground-terminal wire 44 and the base-terminal wire 42 of the NPN transistor 36. The grounded wire 44 is made from one wire of the multiple wire ribbon 18. The grounded wire 44 is exposed 3 mm away from the exposed base-terminal wire 42. A line 42 marks this location on the multiple wire ribbon 18 so that it can be adjusted to the correct elevation. The emitting-terminal wire 40 is connected to the timer 24 at the timer's negative terminal. The timer's positive terminal is connected through the switch 32 to the battery 30. In the circuit case 12 there are five copies of this circuit just described. Each operates without interference from another. Each copy is connected to its own ground-terminal wire 44 and base-terminal 42 wires pair located at a different elevation. In the preferred embodiment the sensors' locations measured from the bottom of the weight 20 are 1″, 3″, 6″, 12″, and 18″. The weight 20 can be made from a 2″ long aluminum rod ½″ in diameter and attached with hot glue. The circuit case 12 encloses the electronic components and allows for the display the timers. It can be made of metal or plastic. The circuit case anchor 14 can be made from a ¼″ diameter aluminum rod 7″ long with the last inch bent at a right angle. The multiple wire ribbon anchor 16 can also be made from a ¼″ aluminum rod.

### Operation

### FIGS. 1 and 2

### Preferred Embodiment

A hole 10 is dug commonly with a post hole digger approximately 5″ in diameter at the test location. It is generally dug to 18″ below the topsoil layer. The hole is then filled with water and the water allowed to absorb for 30 minutes. Then the hole is refilled to the topsoil layer. The next step is to secure the multiple wire ribbon anchor 16 over the center of the hole. The multiple wire ribbon is lowered into the hole and the circuit case is anchored at a point where the weight 20 hangs freely 1 inch from the bottom of the hole. The switch 32 is turned on before the water level drops below the line marking the location of the highest sensor 46. All five analog timers 24 start counting as soon as the switch 32 is turned on. When the water level falls below each exposed ground-terminal wire 38 and base-terminal wire 42 pair of a particular circuit, the timer connected to the sensor will lose voltage and stop timing. After the test is over and water has completely left the hole, each timer 24 will show a different length of time. The time taken for the water surface 22 to drop between any two sensors is found by taking the difference between their timers' values. As an example, after returning to the test site the clocks read 1:30, 1:15, 12:58, 12:28, and 12:05. This means that the water surface took 15 minutes to fall from 18″ to 12″ and 17 minutes to fall from 12″ to 6″. This is the correlation that is regularly found through measuring the water surface elevation at 10-minute intervals for about an hour.

### CONCLUSION, RAMIFICATIONS, AND SCOPE

Accordingly the reader will see that the device of the invention provides a means to find out how fast water has dissipated from a hole without the test needing continual observation. This device has been shown to be simple, compact, lightweight, easy to set up, and inexpensive to fabricate.

While the above description contains many specifics, these should not be construed as limitations on the scope of the invention, but as exemplifications of the presently preferred embodiments thereof. Many other ramifications and variations are possible with the teachings of the invention. For example, the circuitry can be miniaturized to fit into a case the size of a watch. The recorded lengths of time can be stored on an internal memory and the conductivity coefficient of the soil can be calculated. The timers could be digital and a LCD display with buttons could allow the user to input test hole numbers and recall memory. Any number of sensors could be used for greater accuracy. Thus the scope of the invention should be determined by the appended claims and their legal equivalents not to be limited by the example given.

I claim:

1. A device comprising:
a. a series of water detectors situated vertically at different elevations, and
b. one or more timers connected to said water detectors,
whereby the amount of time for a given water-surface to drop from the elevation of one water detector to the elevation of another water detector is recorded.

2. The device of claim 1 wherein said water detector is made of two electrically conductive wires separated by a small gap.

3. The device of claim 1 wherein said water detectors are located on a flexible medium whereby they will hang perpendicular to the water surface.
